(19) United States
(12) Patent Application Publication
(10) Pub. No.: US 2023/0159729 A1
(43) Pub. Date: May 25, 2023

(54) RUBBER COMPOSITION AND TIRE

(71) Applicant: Toyo Tire Corporation, Itami-shi (JP)

(72) Inventors: Yuma Nishikawa, Itami-shi (JP); Norio Minouchi, Itami-shi (JP)

(73) Assignee: Toyo Tire Corporation, Itami-shi (JP)

(21) Appl. No.: 17/984,595

(22) Filed: Nov. 10, 2022

(30) Foreign Application Priority Data
Nov. 25, 2021 (JP) 2021-191495

(51) Int. Cl. C08L 9/06; B60C 1/00

(52) U.S. Cl. CPC C08L 9/06; B60C 1/0016; B60C 1/0025

(57) ABSTRACT

A rubber composition according to an embodiment contains a rubber component and silica. In the rubber component, an amount of a vinyl bond unit derived from butadiene in a total amount of the rubber component is 10 mass % or more, and a content of a solution polymerized styrene-butadiene rubber is less than 50 mass %. A content of the silica is 90 parts by mass to 200 parts by mass, and a content of a metal oxide is less than 0.5 parts by mass, with respect to 100 parts by mass of the rubber component.

### CROSS-REFERENCE TO RELATED APPLICATION

This application is based upon and claims the benefit of priority from the prior Japanese Patent Application No. 2021-191495, filed on Nov. 25, 2021; the entire contents of which are incorporated herein by reference.

### BACKGROUND OF THE INVENTION

### 1. Field of the Invention

The present invention relates to a rubber composition and a tire using the rubber composition.

### 2. Description of the Related Art

A diene rubber is generally used as a rubber component in a rubber composition used for a tire, an anti-vibration rubber, a conveyor belt, or the like, and a metal oxide such as zinc oxide is compounded together with a vulcanization agent such as sulfur and a vulcanization accelerator. A vulcanized rubber is formed by vulcanizing the rubber composition. In such a vulcanization mechanism, a metal oxide such as zinc oxide functions as a vulcanization accelerator activator, and is used as an essential component.

However, in recent years, the metal oxide such as zinc oxide is required to be reduced in a compounding amount from a viewpoint of preventing environmental pollution. Therefore, for example, JP-A-2019-099709 discloses a rubber composition in which 50 mass % or more of a rubber component is a solution polymerized styrene-butadiene rubber. JP-A-2019-099708 discloses a rubber composition in which 50 mass % or more of a rubber component is a solution polymerized styrene-butadiene rubber having a modified molecular terminal.

### SUMMARY OF THE INVENTION

In view of the above, an object of the invention is to provide a rubber composition capable of allowing vulcanization to proceed while reducing an amount of a metal oxide such as zinc oxide or not compounded with the metal oxide such as zinc oxide.

A rubber composition according to the present embodiment contains a rubber component and silica. In the rubber component, an amount of a vinyl bond unit derived from butadiene in a total amount of the rubber component is 10 mass % or more, and a content of a solution polymerized styrene-butadiene rubber is less than 50 mass %. A content of the silica is 90 parts by mass to 200 parts by mass, and a content of a metal oxide is less than 0.5 parts by mass, with respect to 100 parts by mass of the rubber component. Here, the content of the solution polymerized styrene-butadiene rubber being less than 50 mass % includes a case where the content of the solution polymerized styrene-butadiene rubber is 0 mass %, that is, a case where the solution polymerized styrene-butadiene rubber is not contained. In addition, the content of the metal oxide being less than 0.5 parts by mass includes a case where the content of the metal oxide is 0 parts by mass, that is, a case where the metal oxide is not contained.

A tire according to an embodiment of the invention is produced using the above rubber composition.

According to the embodiment of the invention, vulcanization can proceed while reducing the amount of the metal oxide such as zinc oxide or not compounded with the metal oxide such as zinc oxide.

### DESCRIPTION OF EMBODIMENTS

A rubber composition according to an embodiment contains a rubber component in which an amount of a vinyl bond unit derived from butadiene is 10 mass % or more, and silica, in which a content of the silica is 90 parts by mass to 200 parts by mass and a content of a metal oxide is less than 0.5 parts by mass, with respect to 100 parts by mass of the rubber component. Since the metal oxide such as zinc oxide functions as a vulcanization accelerator activator, when an amount of the metal oxide is reduced or the metal oxide is not compounded, vulcanization is usually difficult to proceed. On the other hand, according to the present embodiment in which the amount of the vinyl bond unit is set to 10 mass % or more as described above, vulcanization by a radical mechanism proceeds without containing the metal oxide, and a strength reduction of a vulcanized rubber can be prevented. In addition, since the vinyl bond unit is selectively crosslinked, abrasion resistance of the vulcanized rubber can be improved.

In the rubber composition according to the embodiment, a diene rubber is used as the rubber component. The diene rubber refers to a rubber having a repeating unit corresponding to a diene monomer having a conjugated double bond, and has a double bond in a polymer main chain. Specific examples of the diene rubber include various diene rubbers commonly used in the rubber composition, such as a natural rubber (NR), an isoprene rubber (IR), a butadiene rubber (BR), a styrene-butadiene rubber (SBR), a nitrile rubber (NBR), a chloroprene rubber (CR), a butyl rubber (IIR), a styrene-isoprene copolymer rubber, a butadiene-isoprene copolymer rubber, and a styrene-isoprene-butadiene copolymer rubber. These rubbers may be used alone or in combination of two or more kinds thereof. Among these, the rubber component preferably contains at least one selected from the group consisting of the natural rubber, the styrene-butadiene rubber, and the butadiene rubber. Those obtained by modifying a terminal as necessary (for example, a terminal-modified SBR) or those obtained by modification to impart desired characteristics (for example, a modified NR) are also included in the concept of the diene rubber.

The rubber component may or may not contain a solution polymerized styrene-butadiene rubber (SSBR), and a content thereof is less than 50 mass %. That is, the content of the solution polymerized styrene-butadiene rubber is less than 50 parts by mass in 100 parts by mass of the rubber component. According to the present embodiment, regardless of that the content of the solution polymerized styrene-butadiene rubber is less than 50 mass %, the vulcanization can proceed while reducing the amount of the metal oxide or not compounded with the metal oxide. The content of the solution polymerized styrene-butadiene rubber may be 45 mass % or less, 35 mass % or less, 30 mass % or less, 20 mass % or less, or 0 mass % with respect to 100 mass % of the rubber component.

The rubber component according to the present embodiment contains a diene rubber having a constitutional unit derived from butadiene. Examples of such a diene rubber include a butadiene rubber, a styrene-butadiene rubber, a butadiene-isoprene copolymer rubber, and a styrene-isoprene-butadiene copolymer rubber, and any one or more of these rubbers may be used. More preferably, the rubber component contains at least a styrene-butadiene rubber and/or a butadiene rubber, and optionally other diene rubbers such as a natural rubber.

In one embodiment, the rubber component may contain an emulsion polymerized styrene-butadiene rubber (ESBR), and may contain 30 mass % or more of the emulsion polymerized styrene-butadiene rubber with respect to 100 mass % of the rubber component. The content of the emulsion polymerized styrene-butadiene rubber may be 40 mass % or more, 50 mass % or more, 80 mass % or less, or 70 mass % or less with respect to 100 mass % of the rubber component.

In another embodiment, the rubber component may contain an emulsion polymerized styrene-butadiene rubber, a solution polymerized styrene-butadiene rubber, and optionally a natural rubber. For example, the rubber component may contain 30 mass % or more and 80 mass % or less of the emulsion polymerized styrene-butadiene rubber, 10 mass % or more and less than 50 mass % of the solution polymerized styrene-butadiene rubber, and 0 mass % or more and 40 mass % or less of the natural rubber. More preferably, the rubber component may contain 40 mass % or more and 70 mass % or less of the emulsion polymerized styrene-butadiene rubber, 15 mass % or more and 45 mass % or less of the solution polymerized styrene-butadiene rubber, and 10 mass % or more and 30 mass % or less of the natural rubber.

In still another embodiment, the rubber component may contain an emulsion polymerized styrene-butadiene rubber, a natural rubber, and optionally a butadiene rubber. For example, the rubber component may contain 20 mass % to 60 mass % of the emulsion polymerized styrene-butadiene rubber, 10 mass % to 60 mass % of the natural rubber, and 0 mass % to 60 mass % of the butadiene rubber. More preferably, the rubber component may contain 30 mass % to 50 mass % of the emulsion polymerized styrene-butadiene rubber, 10 mass % to 40 mass % of the natural rubber, and 30 mass % to 60 mass % of the butadiene rubber.

In the present embodiment, in the rubber component, the amount of the vinyl bond unit derived from butadiene in a total amount of the rubber component is 10 mass % or more. The amount of the vinyl bond unit derived from butadiene is a content of the vinyl bond unit derived from butadiene contained in all constitutional units (repeating units of a polymer) of the diene rubber constituting the rubber component, and is mass % of the amount of the vinyl bond unit with respect to 100 mass % of the total amount of the rubber component. The vinyl bond unit derived from butadiene refers to a vinyl 1,2-bond constitutional unit among constitutional units formed of butadiene.

A microstructure of the diene rubber can be measured by a Fourier transform infrared spectroscopy (FT-IR) method. More specifically, the microstructure of BR, NR, and IR are obtained by a Morello method, and the microstructure of SBR is obtained by a Hampton-Morello method. When a plurality of kinds of diene rubbers are compounded and used, the amount (mass %) of the vinyl bond unit derived from butadiene in the rubber component can be obtained based on a content of a vinyl bond unit derived from butadiene measured for each diene rubber (that is, a content (mass %) of a vinyl bond unit derived from butadiene contained in all constitutional units constituting a rubber polymer in each diene rubber) by proportional calculation according to a compounding amount.

The amount of the vinyl bond unit derived from butadiene in the total amount of the rubber component is more preferably 15 mass % or more, still more preferably 18 mass % or more, and may be 20 mass % or more. An upper limit of the amount of the vinyl bond unit derived from butadiene is preferably 80 mass % or less, more preferably 60 mass % or less, still more preferably 50 mass % or less, may be 40 mass % or less, and may be 30 mass % or less.

The rubber composition according to the embodiment contains the silica as a filler. The silica is not particularly limited, and examples thereof include wet silica and dry silica. Preferably, wet silica such as silica made by a wet-type precipitation method or silica made by a wet-type gel-method is used.

In the present embodiment, the silica is compounded in an amount of 90 parts by mass to 200 parts by mass with respect to 100 parts by mass of the rubber component. By compounding a large amount of silica in this manner, a decrease in vulcanization degree can be prevented. The content of the silica is preferably 90 parts by mass to 150 parts by mass, and more preferably 90 parts by mass to 120 parts by mass with respect to 100 parts by mass of the rubber component.

As the filler to be compounded in the rubber composition, the silica may be used alone, or carbon black may be compounded together with the silica. The carbon black is not particularly limited, and various known varieties can be used. Specific examples thereof include SAF grade (N100 series), ISAF grade (N200 series), HAF grade (N300 series), FEF grade (N500 series), GPF grade (N600 series) (and ASTM grade). These grades of the carbon black can be used alone or in combination of two or more thereof.

A content of the carbon black is not particularly limited, and may be 50 parts by mass or less, 1 part by mass to 30 parts by mass, or 2 parts by mass to 10 parts by mass with respect to 100 parts by mass of the rubber component.

A silane coupling agent may be compounded in the rubber composition. Examples of the silane coupling agent include: sulfide silane coupling agents such as bis(3-triethoxysilylpropyl)tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilane coupling agents such as 3-mercaptopropyltrimethoxysilane, 3-mercaptopropyltriethoxysilane, 3-mercaptopropylmethyldimethoxysilane, 3-mercaptopropyldimethylmethoxysilane, and mercaptoethyltriethoxysilane; and thioester group-containing silane coupling agents such as 3-octanoylthio-1-propyltriethoxysilane, 3-propionylthiopropyl trimethoxysilane, 3-hexanoylthio-1-propyltriethoxysilane, and 3-octanoylthio-1-propyltrimethoxysilane. These silane coupling agents may be used alone or in combination of two or more kinds thereof. Among these, it is preferable to use a sulfide silane coupling agent as the silane coupling agent.

A content of the silane coupling agent Is not particularly limited, and is preferably 2 mass % to 25 mass % of an amount of the silica, that is, 2 parts by mass to 25 parts by mass, and more preferably 5 parts by mass to 20 parts by mass with respect to 100 parts by mass of the silica.

In the rubber composition according to the present embodiment, from a viewpoint of preventing environmental pollution, the content of the metal oxide is less than 0.5 parts by mass, more preferably less than 0.2 parts by mass, and still more preferably 0 part by mass, that is, no metal oxide, with respect to 100 parts by mass of the rubber component. Here, the content of the metal oxide is a total amount when a plurality of kinds of metal oxides are contained.

The metal oxide is an oxide of a metallic element, and an oxide containing a metalloid element is not included in the metal oxide. Here, in the periodic table, the metallic element is an element (excluding hydrogen) located on a left of a line connecting boron, silicon, germanium, antimony, and bismuth (metalloid elements). Typical examples of the metal oxide include zinc oxide, and others include magnesium oxide and calcium oxide.

In the rubber composition according to the present embodiment, in addition to the components described above, various additives generally used in the rubber composition, such as an oil, stearic acid, an antioxidant, a wax, a vulcanization agent, and a vulcanization accelerator, may be compounded.

Examples of the antioxidant include an aromatic amine-based antioxidant, an amine-ketone-based antioxidant, a monophenol-based antioxidant, a bisphenol-based antioxidant, a polyphenol-based antioxidant, a dithiocarbamate-based antioxidant, and a thiourea-based antioxidant. These antioxidants may be used alone or in combination of two or more kinds thereof. A content of the antioxidant is not particularly limited, and may be, for example, 0.5 parts by mass to 10 parts by mass with respect to 100 parts by mass of the rubber component.

As the vulcanization agent, sulfur is preferably used, and examples thereof include powdered sulfur, precipitated sulfur, insoluble sulfur, and highly dispersible sulfur. A content of the vulcanization agent is not particularly limited, and may be, for example, 0.1 parts by mass to 10 parts by mass or 0.5 parts by mass to 5 parts by mass with respect to 100 parts by mass of the rubber component.

Examples of the vulcanization accelerator include various vulcanization accelerators such as sulfenamide-based, thiuram-based, thiazole-based, and guanidine-based vulcanization accelerators, which may be used alone or in combination of two or more kinds thereof. A compounding amount of the vulcanization accelerator is not particularly limited, and may be, for example, 0.1 parts by mass to 10 parts by mass or 0.5 parts by mass to 5 parts by mass with respect to 100 parts by mass of the rubber component.

The rubber composition according to the present embodiment can be produced by kneading according to a common method by using a mixer such as a Banbury mixer, a kneader, or a roll that is generally used. For example, in a first mixing stage (non-productive kneading step), the silica and an additive other than a vulcanization agent and a vulcanization accelerator are added to the rubber component. Next, in a final mixing stage (productive kneading step), a vulcanization agent and a vulcanization accelerator are added to and mixed with the obtained mixture to prepare an unvulcanized rubber composition.

The rubber composition according to the present embodiment can be used for various rubber members such as a tire, an anti-vibration rubber, and a conveyor belt. Preferably, the rubber composition is used for a tire, and can be applied to various applications such as a tire for a passenger vehicle and a large-sized tire for a truck or a bus, and various parts of a tire such as a tread, a sidewall, and a bead of a pneumatic tire having various sizes.

In one embodiment, a tire including a rubber portion (for example, tread rubber or side wall rubber) made of the above rubber composition is manufactured as follows. The rubber composition is molded into a predetermined shape by a common method, for example, by extrusion. A green tire is produced by combining the obtained molded product with other parts. By vulcanization molding the green tire at, for example, 140° C. to 180° C., a pneumatic tire can be manufactured.

### EXAMPLES

Hereinafter, Examples will be illustrated, but the invention is not limited to these Examples.

The components used in Examples and Comparative Examples are as follows.
SBR1: solution polymerized styrene-butadiene rubber (terminal-modified), “HPR350” (styrene content: 20.5 mass %, microstructure of butadiene moiety, vinyl content: 55.5 mass %, amount of vinyl bond unit derived from butadiene: 44.1 mass %) manufactured by JSR Corporation
SBR2: emulsion polymerized styrene-butadiene rubber, “SBR1723” (styrene content: 23.5 mass %, microstructure of butadiene moiety, vinyl content: 19 mass %, amount of vinyl bond unit derived from butadiene: 14.5 mass %, oil extended: 37.5 phr) manufactured by JSR Corporation
BR1: butadiene rubber, “EUROPRENE BR HV80” (amount of vinyl bond unit: 77 mass %) manufactured by Versalis S.p.A.
BR2: butadiene rubber, “BR150B” (amount of vinyl bond unit: 1 mass %) manufactured by Ube Industries Ltd.
NR: natural rubber “RSS #3”
Carbon black: “SEAST 3” manufactured by Tokai Carbon Co., Ltd.
Silica: “Ultrasil VN3” manufactured by Evonik Industries
Silane coupling agent: bis(3-triethoxysilylpropyl)tetrasulfide, “Si69” manufactured by Evonik
Oil: “Process NC-140” manufactured by JXTG Energy Corporation
Zinc oxide: “Zinc Oxide No. 2” manufactured by Mitsui Mining & Smelting Co., Ltd.
Stearic acid: “LUNAC S-20” manufactured by Kao Corporation
Antioxidant: “ANTIGEN 6C” manufactured by Sumitomo Chemical Co., Ltd.
Sulfur: “5% oil-filled powdered sulfur” manufactured by Tsurumi. Chemical Industry Co., Ltd.
Vulcanization accelerator CBS: “NOCCELER CZ-G (CZ)” manufactured by Ouchi Shinko Chemical Industrial Co., Ltd.
Vulcanization accelerator DPG: “NOCCELER D” manufactured by Ouchi Shinko Chemical Industrial Co., Ltd.

Evaluation methods in Examples and Comparative Examples are as follows.

### (1) Vulcanization Property (MH-ML)

In a vulcanization behavior measurement test at 160° C. for an unvulcanized rubber composition by a rheometer, (MH-ML) was calculated when MH was a maximum torque value and ML was a minimum torque value. (MH-ML) in Comparative Example 1 in Table 1, (MH-ML) in Comparative Example 3 in Table 2, (MH-ML) in Comparative Example 4 in Table 3, (MH-ML) in Comparative Example 5 in Table 4, (MH-ML) in Comparative Example 6 in Table 5, and (MH-ML) in Comparative Example 7 in Table 6 were each evaluated by an index of 100. A smaller index indicates that sulfur vulcanization does not sufficiently proceed.

### (2) Breaking Strength

A rubber sample obtained by vulcanizing the unvulcanized rubber composition at 175° C. for 15 minutes was used. Breaking strength (MPa) of the sample prepared by using a JIS No. 3 dumbbell was measured in accordance with JIS K6251. The breaking strength in Comparative Example 1 in Table 1, the breaking strength in Comparative Example 3 in Table 2, the breaking strength in Comparative Example 4 in Table 3, the breaking strength in Comparative Example 5 in Table 4, the breaking strength in Comparative Example 6 in Table 5, and the breaking strength in Comparative Example 7 in Table 6 were each evaluated by an index of 100. The larger the value, the higher the breaking strength.

### (3) Abrasion Resistance

A rubber sample obtained by vulcanizing the unvulcanized rubber composition at 175° C. for 15 minutes was used. An abrasion loss was measured under conditions of a load of 40 N and a slip ratio of 30% by using a Lambourn abrasion tester manufactured by Iwamoto Seisakusho Co., Ltd in accordance with JIS K6264. A reciprocal of the abrasion loss in Comparative Example 1 in Table 1, a reciprocal of the abrasion loss in Comparative Example 3 in Table 2, a reciprocal of the abrasion loss in Comparative Example 4 in Table 3, a reciprocal of the abrasion loss in Comparative Example 5 in Table 4, a reciprocal of the abrasion loss in Comparative Example 6 in Table 5, and a reciprocal of the abrasion loss in Comparative Example 7 in Table 6 were each evaluated by an index of 100. The larger the value, the less the abrasion loss, and the better the abrasion resistance.

### Comparative Examples 1 and 2

First, a compounding ingredient excluding sulfur and a vulcanization accelerator was added to a rubber component in a first mixing stage in accordance with compounding (part by mass) shown in Table 1 below by using a Banbury mixer and kneaded (discharge temperature=150° C.). Next, sulfur and a vulcanization accelerator were added to the obtained kneaded material in a final mixing stage and kneaded (discharge temperature=90° C.). The rubber compositions thus obtained were evaluated for the vulcanization property, the breaking strength, and the abrasion resistance. Results are shown in Table 1. The “amount of vinyl bond unit” in Table 1 indicates an amount of a vinyl bond unit derived from butadiene in a total amount of the rubber component, and was calculated based on a content of the vinyl bond unit derived from butadiene for each diene rubber by proportional calculation according to a compounding amount (the same in Tables 2 to 6). In addition, regarding a compounding amount of SBR2, a value in parentheses indicates an amount of a rubber polymer excluding an oil extended component (the same in Tables 2 to 5).

TABLE 1

| | Comparative | Comparative |
|---|---|---|
| | Examp1e 1 | Example 2 |
| Compounding (part by mass) | | |
| SBR2 | 82.5 (60) | 82.5 (60) |
| BR2 | 20 | 20 |
| NR | 20 | 20 |
| Carbon black | 5 | 5 |
| Silica | 90 | 90 |
| Silane coupling agent | 9 | 9 |
| Oil | 5 | 5 |
| Zinc oxide | 2 | — |
| Stearic acid | 2 | 2 |
| Antioxidant | 2 | 2 |
| Sulfur | 2 | 2 |
| Vulcanization accelerator | 1.5 | 1.5 |
| CBS | | |
| Vulcanization accelerator | 0.5 | 0.5 |
| DPG | | |
| Amount of vinyl bond unit | 8.9 | 8.9 |
| (mass %) | | |
| Evaluation | | |
| Vulcanization property | 100 | 75 |
| (MH − ML) | | |
| Breaking strength | 100 | 85 |
| Abrasion resistance | 100 | 108 |

### Examples 1 and 2 and Comparative Example 3

Each rubber composition was prepared in the same manner as in Comparative Example 1 except for compounding (part by mass) shown in Table 2 below. The obtained rubber compositions were evaluated for the vulcanization property, the breaking strength, and the abrasion resistance. Results are shown in Table 2.

TABLE 2

| | Comparative | | |
|---|---|---|---|
| | Example 3 | Example 1 | Example 2 |
| Compounding (part by mass) | | | |
| SBR1 | 45 | 45 | 45 |
| SBR2 | 75.625 (55) | 75.625 (55) | 75.625 (55) |
| Carbon black | 5 | 5 | 5 |
| Silica | 90 | 90 | 90 |
| Silane coupling agent | 9 | 9 | 9 |
| Oil | 5 | 5 | 5 |
| Zinc oxide | 2 | 0.3 | — |
| Stearic acid | 2 | 2 | 2 |
| Antioxidant | 2 | 2 | 2 |
| Sulfur | 2 | 2 | 2 |
| Vulcanization accelerator | 1.5 | 1.5 | 1.5 |
| CBS | | | |
| Vulcanization accelerator | 0.5 | 0.5 | 0.5 |
| DPG | | | |
| Amount of vinyl bond unit | 27.8 | 27.8 | 27.8 |
| (mass %) | | | |
| Evaluation | | | |
| Vulcanization property | 100 | 100 | 103 |
| (MH − ML) | | | |
| Breaking strength | 100 | 100 | 98 |
| Abrasion resistance | 100 | 106 | 118 |

### Examples 3 and 4 and Comparative Example 4

Each rubber composition was prepared in the same manner as in Comparative Example 1 except for compounding (part by mass) shown in Table 3 below. The obtained rubber compositions were evaluated for the vulcanization property, the breaking strength, and the abrasion resistance. Results are shown in Table 3.

TABLE 3

| | Comparative | | |
|---|---|---|---|
| | Example 4 | Example 3 | Example 4 |
| Compounding (part by mass) | | | |
| SBR1 | 35 | 35 | 35 |
| SBR2 | 61.88 (45) | 61.88 (45) | 61.88 (45) |
| NR | 20 | 20 | 20 |
| Carbon black | 5 | 5 | 5 |
| Silica | 100 | 100 | 100 |
| Silane coupling agent | 10 | 10 | 10 |
| Oil | 10 | 10 | 10 |
| Zinc oxide | 2 | 0.3 | — |
| Stearic acid | 2 | 2 | 2 |
| Antioxidant | 2 | 2 | 2 |
| Sulfur | 2 | 2 | 2 |
| Vulcanization accelerator | 1.5 | 1.5 | 1.5 |
| CBS | | | |
| Vulcanization accelerator | 0.5 | 0.5 | 0.5 |
| DPG | | | |
| Amount of vinyl bond unit | 22.0 | 22.0 | 22.0 |
| (mass %) | | | |
| Evaluation | | | |
| Vulcanization property | 100 | 100 | 102 |
| (MH − ML) | | | |
| Breaking strength | 100 | 105 | 102 |
| Abrasion resistance | 100 | 110 | 113 |

### Examples 5 and 6 and Comparative Example 5

Each rubber composition was prepared in the same manner as in Comparative Example 1 except for compounding (part by mass) shown in Table 4 below. The obtained rubber compositions were evaluated for the vulcanization property, the breaking strength, and the abrasion resistance. Results are shown in Table 4.

TABLE 4

| | Comparative | | |
|---|---|---|---|
| | Example 5 | Example 5 | Example 6 |
| Compounding (part by mass) | | | |
| SBR1 | 15 | 15 | 15 |
| SBR2 | 89.38 (65) | 89.38 (65) | 89.38 (65) |
| NR | 20 | 20 | 20 |
| Carbon black | 5 | 5 | 5 |
| Silica | 100 | 100 | 100 |
| Silane coupling agent | 10 | 10 | 10 |
| Oil | 5 | 5 | 5 |
| Zinc oxide | 2 | 0.3 | — |
| Stearic acid | 2 | 2 | 2 |
| Antioxidant | 2 | 2 | 2 |
| Sulfur | 2 | 2 | 2 |
| Vulcanization accelerator | 1.5 | 1.5 | 1.5 |
| CBS | | | |
| Vulcanization accelerator | 0.5 | 0.5 | 0.5 |
| DPG | | | |
| Amount of vinyl bond unit | 16.0 | 16.0 | 16.0 |
| (mass %) | | | |
| Evaluation | | | |
| Vulcanization property | 100 | 101 | 99 |
| (MH − ML) | | | |
| Breaking strength | 100 | 99 | 100 |
| Abrasion resistance | 100 | 108 | 110 |

### Examples 7 and 8 and Comparative Example 6

Each rubber composition was prepared in the same manner as in Comparative Example 1 except for compounding (part by mass) shown in Table 5 below. The obtained rubber compositions were evaluated for the vulcanization property, the breaking strength, and the abrasion resistance. Results are shown in Table 5.

TABLE 5

| | Comparative | | |
|---|---|---|---|
| | Example 6 | Example 7 | Example 8 |
| Compounding (part by mass) | | | |
| SBR2 | 41.25 (30) | 41.25 (30) | 41.25 (30) |
| NR | 20 | 20 | 20 |
| BR1 | 20 | 20 | 20 |
| BR2 | 30 | 30 | 30 |
| Carbon black | 5 | 5 | 5 |
| Silica | 100 | 100 | 100 |
| Silane coupling agent | 10 | 10 | 10 |
| Oil | 15 | 15 | 15 |
| Zinc oxide | 2 | 0.3 | — |
| Stearic acid | 2 | 2 | 2 |
| Antioxidant | 2 | 2 | 2 |
| Sulfur | 2 | 2 | 2 |
| Vulcanization accelerator | 1.5 | 1.5 | 1.5 |
| CBS | | | |
| Vulcanization accelerator | 0.5 | 0.5 | 0.5 |
| DPG | | | |
| Amount of vinyl bond unit | 20.1 | 20.1 | 20.1 |
| (mass %) | | | |
| Evaluation | | | |
| Vulcanization property | 100 | 99 | 95 |
| (MH − ML) | | | |
| Breaking strength | 100 | 103 | 100 |
| Abrasion resistance | 100 | 106 | 112 |

### Examples 9 and 10 and Comparative Example 7

Each rubber composition was prepared in the same manner as in Comparative Example 1 except for compounding (part by mass) shown in Table 6 below. The obtained rubber compositions were evaluated for the vulcanization property, the breaking strength, and the abrasion resistance. Results are shown in Table 6.

TABLE 6

| | Comparative | | |
|---|---|---|---|
| | Example 7 | Example 9 | Example 10 |
| Compounding (part by mass) | | | |
| SBR1 | 40 | 40 | 40 |
| NR | 25 | 25 | 25 |
| BR1 | 15 | 15 | 15 |
| BR2 | 20 | 20 | 20 |
| Carbon black | 5 | 5 | 5 |
| Silica | 120 | 120 | 120 |
| Silane coupling agent | 12 | 12 | 12 |
| Oil | 40 | 40 | 40 |
| Zinc oxide | 2 | 0.3 | — |
| Stearic acid | 2 | 2 | 2 |
| Antioxidant | 2 | 2 | 2 |
| Sulfur | 2 | 2 | 2 |
| Vulcanization accelerator | 1.5 | 1.5 | 1.5 |
| CBS | | | |
| Vulcanization accelerator | 0.5 | 0.5 | 0.5 |
| DPG | | | |
| Amount of vinyl bond unit | 29.4 | 29.4 | 29.4 |
| (mass %) | | | |
| Evaluation | | | |
| Vulcanization property | 100 | 104 | 110 |
| (MH − ML) | | | |
| Breaking strength | 100 | 101 | 108 |
| Abrasion resistance | 100 | 105 | 120 |

As shown in Table 1, in Comparative Example 2 in which zinc oxide is not compounded, vulcanization does not proceed sufficiently and the breaking strength is significantly deteriorated compared to Comparative Example 1 in which zinc oxide is compounded. In this way, in a case where the amount of the vinyl bond unit derived from butadiene is less than 10 mass %, since a crosslinking density decreases when zinc oxide is not compounded, the abrasion resistance is improved, but the breaking strength is deteriorated.

On the other hand, as shown in Tables 2 to 6, when the amount of the vinyl bond unit derived from butadiene is 10 mass % or more, in Examples 1 to 10 in which an amount of zinc oxide is reduced or zinc oxide is not compounded, vulcanization proceeds to the same degree as in Comparative Examples 3 to 7 in which zinc oxide is compounded, and a decrease in breaking strength is prevented. In addition, in Examples 1 to 10, the abrasion resistance is excellent compared to Comparative Examples 3 to 7.

In various numerical ranges described in the specification, upper limit values and lower limit values thereof can be freely combined, and all combinations thereof are described in the present specification as preferable numerical ranges. In addition, the description of the numerical range of “X to Y” means X or more and Y or less.

Although certain embodiments of the invention have been described above, these embodiments have been presented by way of example only, and are not intended to limit the scope of the invention. These embodiments can be implemented in various other forms, and various omissions, substitutions, and changes can be made without departing from the spirit of the invention. These embodiments, their omissions, substitutions, changes, and the like are included in the invention described in the scope of claims and equivalents thereof, as well as being included in the scope and gist of the invention.

What is claimed is:

1. A rubber composition comprising:
a rubber component; and
silica, wherein
in the rubber component, an amount of a vinyl bond unit derived from butadiene in a total amount of the rubber component is 10 mass % or more, and a content of a solution polymerized styrene-butadiene rubber is less than 50 mass %, and
a content of the silica is 90 parts by mass to 200 parts by mass, and a content of a metal oxide is less than 0.5 parts by mass, with respect to 100 parts by mass of the rubber component.

2. The rubber composition according to claim 1, wherein the amount of the vinyl bond unit derived from butadiene in the total amount of the rubber component is 80 mass % or less.

3. The rubber composition according to claim 1, wherein the amount of the vinyl bond unit derived from butadiene in the total amount of the rubber component is 15 mass % to 30 mass %.

4. The rubber composition according to claim 1, wherein the rubber component contains 30 mass % to 80 mass % of an emulsion polymerized styrene-butadiene rubber.

5. The rubber composition according to claim 1, wherein the rubber component contains 30 mass % to 80 mass % of an emulsion polymerized styrene-butadiene rubber and 10 mass % or more and less than 50 mass % of the solution polymerized styrene-butadiene rubber.

6. The rubber composition according to claim 1, wherein the rubber component contains 40 mass % to 70 mass % of an emulsion polymerized styrene-butadiene rubber, 15 mass % to 45 mass % of the solution polymerized styrene-butadiene rubber, and 10 mass % to 30 mass % of a natural rubber.

7. The rubber composition according to claim 1, wherein the rubber component contains 30 mass % to 50 mass % of an emulsion polymerized styrene-butadiene rubber, 10 mass % to 40 mass % of a natural rubber, and 30 mass % to 60 mass % of a butadiene rubber.

8. A tire, which is produced using the rubber composition according to claim 1.

9. A tire, which is produced using the rubber composition according to claim 2.

10. A tire, which is produced using the rubber composition according to claim 3.

11. A tire, which is produced using the rubber composition according to claim 4.

12. A tire, which is produced using the rubber composition according to claim 5.

13. A tire, which is produced using the rubber composition according to claim 6.

14. A tire, which is produced using the rubber composition according to claim 7.
